(19) United States
(12) Patent Application Publication
(10) Pub. No.: US 2025/0384458 A1
(43) Pub. Date: Dec. 18, 2025

(54) Real-Time Processing of Transactions for Instant Rewards

(71) Applicant: Capital One Services, LLC, McLean, VA (US)

(72) Inventors: Joseph Fortman, Milwaukee, WI (US); Eve G. Young, Glen Allen, VA (US); Josiah Denton, Chester, VA (US); Pramod Poojary, Hoffman Estates, IL (US); Jack Holloway, New York, NY (US); Amandeep Kalotra, Arlington Heights, IL (US); Andrew Harris, Brooklyn, NY (US); Justin R. Knowles, Midlothian, VA (US); Michael Judge, Glen Allen, VA (US); Dana Mace, Mechanicsville, VA (US); Anup Thomas, Alpharetta, GA (US); Luke Carrico, California, MD (US)

(21) Appl. No.: 18/741,916

(22) Filed: Jun. 13, 2024

(51) Int. Cl. G06Q 30/0226; G06N 3/082; G06Q 30/0238

(52) U.S. Cl. CPC G06Q 30/0233; G06N 3/082; G06Q 30/0238

(57) ABSTRACT

Systems, methods, and apparatuses are described for providing instant reward gratification. A computing device may receive a rewards notification threshold and may receive an indication of an authorization of a transaction conducted by a user. The computing device may then process transaction data corresponding to the transaction to identify a predicted quantity of rewards. The computing device may determine, using a machine learning model, a predicted difference between the authorized amount of the transaction and a predicted posted amount of the transaction. The computing device may also determine a frequency that one or more second transactions similar to the transaction settle. The computing device may then cause output, on a mobile device associated with the user, of a notification indicating the predicted quantity of rewards. The computing device may cause a database to store an association between an account of the user and the predicted quantity of rewards.

### FIELD OF USE

Aspects of the disclosure relate generally to the processing of transaction data. More particularly, aspects described herein describe a process for near-instant provisioning of rewards based on real-time transaction activity.

### BACKGROUND

To incentivize certain transaction activity, organizations may provide one or more rewards to users based on their transaction activity. For example, an organization might provide rewards (e.g., in the form of points, gifts, or the like) for shopping at particular stores and/or using a particular credit card. Such rewards are typically provided in batches at periodic intervals, such as at the end of a payment period, a certain number of days, or the like. This approach is typically taken because it allows the rewards-providing organization to ensure that the appropriate conditions for the reward are met: for example, it gives the organizations time to confirm that a user actually shopped at a particular merchant, that a particular purchase was not temporary and/or immediately refunded, or the like.

One issue with the conventional provisioning of rewards is that the delay between purchase activity and the provisioning of rewards can be undesirably long. For instance, many credit card companies provide batches of credit card points at the end of a statement period, which can be days (if not weeks, if not up to an entire month) after relevant purchase(s) were made. This has significant undesirable implications when it comes to incentivizing individual purchasing behavior: after all, if a particular reward for using a certain credit card at a certain gas station is only provided weeks after the purchase is actually made, a customer is unlikely to remember (or even notice the reward) and adjust their behavior in the future accordingly. In fact, it is not uncommon for some customers to completely forget credit card rewards (e.g., to forget about the existence of loyalty points) because the rewards are provided in a manner that is somewhat disconnected from the related purchase(s).

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to providing automatic and instant reward gratification for consumers by providing access to rewards based on transactions after those transactions are conducted and, e.g., well before those transactions are posted. As will be described in greater detail below, a user might set a rewards notification threshold (e.g., rewards of greater than $10 in cash value) and might some time later conduct a transaction. A computing device might use machine learning techniques to determine a difference between an authorized amount of a transaction (e.g., a $100 initial charge at a restaurant) and a predicted posted amount of the transaction (e.g., a $120 posted amount, accounting for a $20 tip). The computing device may also compare the transaction to past transactions to determine a likelihood that the transaction will settle (and, e.g., not be refunded). Based on the rewards notification threshold and the likelihood that the transaction will post, the computing device may notify a user (e.g., on their mobile phone) of a predicted quantity of awards (e.g., a $15 coupon, which exceeds the $10 rewards threshold set by the user). Those rewards might be immediately usable by the user. Moreover, the rewards might be later adjusted: for example, if the user actually left a $30 tip (for a total posted charge of $130), the coupon might be increased to $20. In this manner, the computing device might automatically provide instant access to rewards, even where those rewards might be later adjusted based on finalized transactions.

More particularly, a computing device may receive, from a user, a rewards notification threshold. The computing device may then receive an indication of an authorization of a transaction conducted by the user. Then, based on the authorization of the transaction, the computing device may process transaction data corresponding to the transaction to identify a predicted quantity of rewards. Those rewards might be identified based on, for example, a determination that the transaction was conducted at a particular merchant, using a particular payment method, or the like. The computing device may provide, as input to a trained machine learning model, at least a portion of the transaction data that indicates an authorized amount of the transaction and then receive, as output from the trained machine learning model, output indicating a predicted difference between the authorized amount of the transaction and a predicted posted amount of the transaction. That predicted difference may comprise an indication of a quantity of a tip, tax, or the like. The computing device may then determine, by comparing the transaction data to a history of financial transactions, a frequency that one or more second transactions similar to the transaction settle. Then, the computing device may cause, based on comparing the predicted posted amount of the transaction to the rewards notification threshold, and based on the frequency that the one or more second transactions similar to the transaction settle, output, on a mobile device associated with the user, of a notification indicating the predicted quantity of rewards. Based on user input received in response to the notification, the computing device may cause a database to store an association between an account of the user and the predicted quantity of rewards. That storing may be performed before the transaction is posted. That predicted quantity of rewards may be immediately usable by the user. Then, based on determining that a predetermined period of time (e.g., the posting of the transaction) has elapsed, the computing device modify the association to indicate a final quantity of rewards. That final quantity of rewards may be greater than the predicted quantity of rewards.

The computing device may train and/or re-train the machine learning model. For example, the computing device may generate the trained machine learning model by training, based on training data comprising a second history of financial transactions, a machine learning model to identify a difference between authorized amounts and corresponding posted amounts. In that context, training the machine learning model may comprise modifying, based on the training data, one or more weights of one or more nodes of an artificial neural network. The computing device may additionally and/or alternatively further train the trained machine learning model based on a second difference between a final posted amount of the transaction and the authorized amount of the transaction.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure

FIG. 3 depicts a method comprising steps for providing instant reward gratification.

FIG. 4 depicts a notification for instant rewards.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, transaction rewards (e.g., credit cards points, loyalty points, cash back rewards, physical gifts for certain purchases) are typically provided to consumers long after a transaction has been completed (and, generally, when the transactions are posted, such as to an account ledger). This slowness is undesirable (as consumers often forget about the rewards or otherwise do not experience a direct link between a transaction and rewards), but is generally implemented because it protects rewards providers from last-minute unexpected changes. For instance, a rewards provider might not want to provide rewards when transactions are not completed (e.g., due to funds insufficiency), when transactions are refunded and/or subject to chargeback, when rewards might be too low because they do not account for tips, or the like. In other words, technical limitations (e.g., the inability to validate and process transactions sufficiently quickly) result in a fundamental issue (e.g., the inability to provide quick and useful rewards), rendering the system as a whole less desirable.

One fundamental issue with the provision of rewards is that transaction processing, particularly in the context of payment cards, is generally broken into three steps: authorization, settlement, and posting. Authorization generally indicates an entitlement of a user to conduct a transaction (e.g., via validation of the details of a credit card, a sufficient amount of funds in a debit card account, or the like), settlement indicates the transfer of funds (e.g., from bank to bank), and the posting often refers to the posting of relevant transaction details to a ledger. There is often a one-to-two-day delay between authorization and posting, and thus rewards software is often built to process batches of days-old transaction data when apportioning rewards.

To remedy these and other issues, aspects described herein use specific processing and machine learning techniques to provide instant reward gratification by, in some cases, allowing users to immediately access and redeem rewards after a transaction has been performed (and, e.g., not long after). The net effect of this process is to provide real-time processing of rewards events (e.g., card loyalty events) to engage consumers immediately after transactions. To perform this functionality, the computing device may predict a quantity of rewards and use a trained machine learning model to determine any differences between an authorized amount of a transaction and a predicted posted amount of the transaction (that is, a difference between the authorized amount and the amount that might ultimately appear on a billing statement or the like). The computing device may also determine a likelihood that the transaction will settle (and, e.g., not be refunded, charged back, or the like) by comparing the transaction to a history of financial transactions. Based on such steps, the computing device might output, to a user, a notification indicating the predicted quantity of rewards. The user might thereby have immediate access to those rewards and might be able to, for example, redeem them in future transactions. Moreover, the rewards might be later tweaked: for example, if the user was in fact entitled to more rewards (due to an especially generous tip, an unexpectedly higher posted amount, or the like), then the user might be provided additional rewards later.

Aspects described herein improve the functioning of computers by improving transaction processing systems and enabling them to provide access to content that would otherwise require significantly more time and manual involvement. As described above, present systems do not provide quick access to rewards because, among other reasons, there is often a concern that those rewards might be provided in circumstances where a transaction is later refunded, charged back, or the like. Aspects described herein leverage machine learning and data processing techniques to avoid this result. Specifically, through a particular arrangement of multiple computing devices and specific processing steps, aspects described herein allow a user to gain access to digital assets (such as rewards points redeemable online) significantly more quickly and reliably than other methods. Human beings could not perform such steps due to the volume of transactions involved, the involvement of machine learning techniques, and the like. Moreover, even if some aspects of the present disclosure might use somewhat conventional technology (e.g., the idea that a user might have a mobile device), the system as a whole nonetheless recites an improvement to technology.

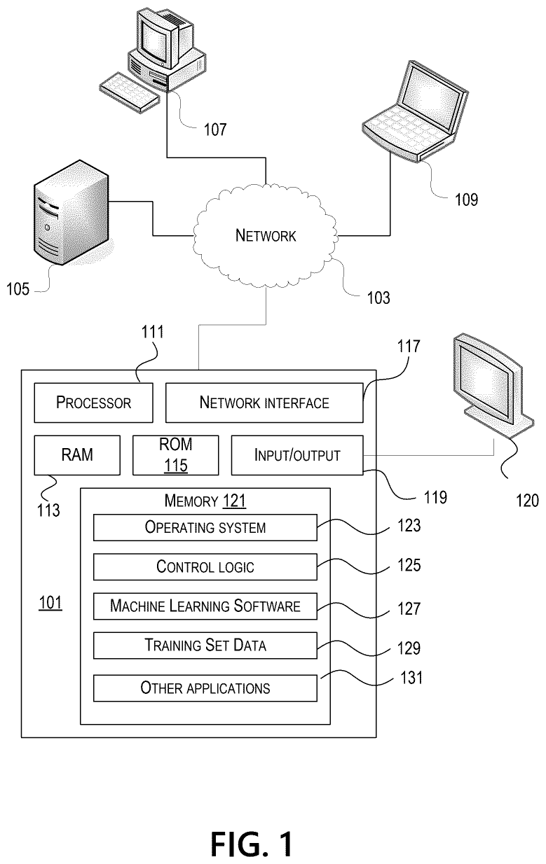

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

FIG. 1 also shows that the computing device 101 may comprise a Hardware Security Module (HSM) 132 and/or a Quantum Random Number Generator (QRNG) 133. The HSM 132 may comprise any computing module (e.g., one or more computer chips, attached cards, or the like) which may be capable of managing secrets, performing encryption and/or decryption, and/or otherwise performing security- and/or authentication-related functions. The HSM 132 may comprise, for instance, one or more secure cryptoprocessor chips which are capable of performing cryptographic operations. The QRNG 133 may comprise any computing module (e.g., one or more computer chips, attached cards, or the like) capable of generating a random number. Such a random number might be generated using quantum methods which permit the random number to have a high degree of entropy.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

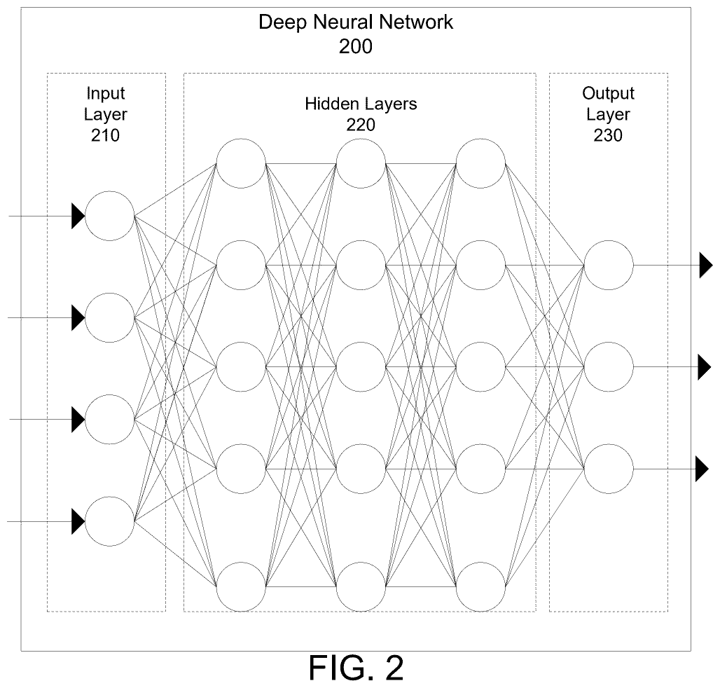

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

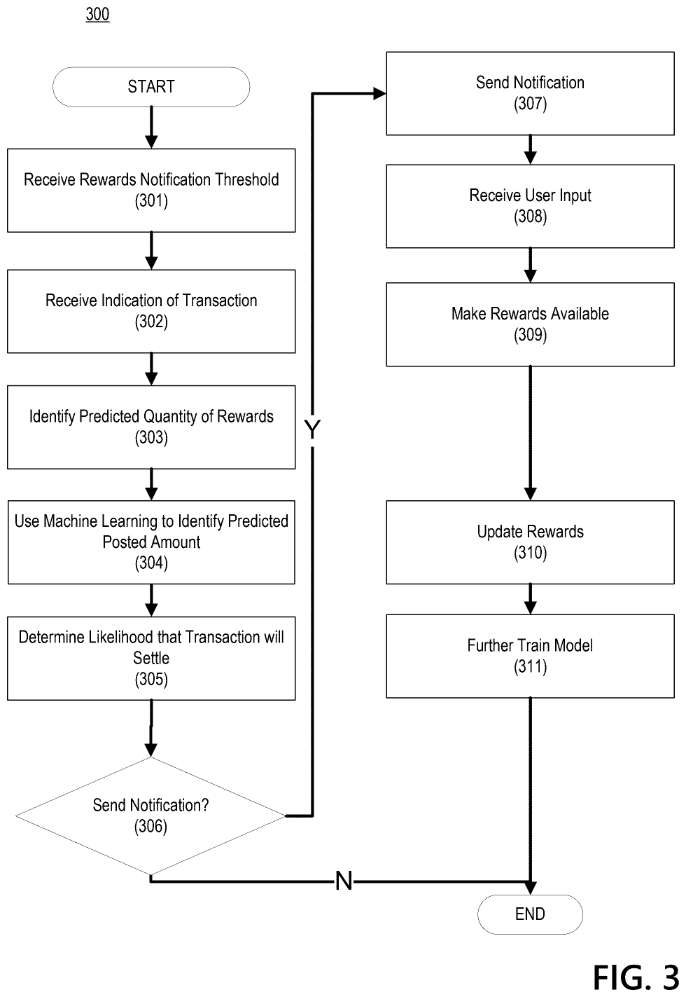

FIG. 3 depicts a method 300 comprising steps for providing instant rewards gratification which may be performed by a computing device, such as any one of the devices described with respect to FIG. 1 and/or FIG. 2. The steps shown in FIG. 3 are illustrative, and may be re-arranged, omitted, and/or modified as desired. A computing device may comprise one or more processors and memory storing instructions that, when executed by the one or more processors, cause the performance of one or more of the steps depicted in FIG. 3. One or more non-transitory computer-readable media may store instructions that, when executed, cause the performance of one or more of the steps depicted in FIG. 3.

In step 301, a computing device may receive a rewards notification threshold. A rewards notification threshold may comprise any conditions upon which a user may or might not be notified regarding rewards, such as the apportionment of rewards in response to a transaction. This threshold may be received by the user through a user interface. For example, the computing device may receive, from a user, a rewards notification threshold. The rewards notification threshold might specify, for example, that only rewards of at least a certain monetary value (e.g., $10) cause transmission of a notification. Additionally and/or alternatively, the rewards notification threshold might specify that notifications can only originate with respect to certain merchants and/or merchant categories (e.g., gas stations but not restaurants), with respect to certain times (e.g., during the day but not during the night), and the like.

In step 302, the computing device may receive an indication of a transaction. The indication of the transaction may comprise any indication of a transaction, whether or not the transaction is completed and/or authorized. For example, the computing device may receive an indication of an authorization of a transaction conducted by the user. As another example, the computing device may receive an indication of an instantiation of a transaction conducted by the user. The indication may be received from the user (e.g., through their mobile device or web browser and as part of a checkout process on an online store), from a merchant (e.g., via a point-of-sale device used to conduct the transaction), or the like.

In step 303, the computing device may identify a predicted quantity of rewards. The predicted quantity of rewards may comprise a prediction of an amount of rewards that would be provided to the user upon completion of (e.g., posting of) the transaction. For example, the computing device may, based on the authorization of the transaction, process transaction data corresponding to the transaction to identify a predicted quantity of rewards. The predicted quantity of awards may comprise a predicted quantity of points, a predicted quantity of currency, the availability of one or more items, the availability of one or more discount codes, or the like.

As used herein, the term rewards may refer to a broad set of incentives for conducting transactions, and need not be limited to points-style rewards. For instance, the rewards described herein may include gifts (e.g., branded merchandise), coupon codes, intangible digital assets (e.g., non-fungible tokens, video game assets and/or currency), or the like. Multiple different types of rewards may be provided and, e.g., selected by users in a manner similar to how the rewards notification threshold is selected. For instance, while one user might prefer rewards points redeemable for travel expenses, another user might prefer direct cash back.

Identifying the predicted quantity of rewards may comprise determining whether the transaction data indicates the fulfillment of one or more conditions. Such conditions may include conducting transactions at a particular merchant, conducting transactions exceeding a particular amount (e.g., a minimum spend), conducting transactions during a certain time of day, conducting transactions in specific locations (e.g., specific towns), buying specific items, or the like. For example, the computing device may determine, based on the transaction data, whether the transaction was conducted at a particular merchant. As another example, the computing device may determine, based on the transaction data, whether the transaction amount exceeds a minimum spend threshold. As yet another example, the computing device may determine, based on the transaction data, whether the transaction was conducted within a particular geographic region.

In step 304, the computing device may use machine learning to identify a predicted posted amount of the transaction. Various machine learning models (e.g., those described with respect to FIG. 2) may be implemented with respect to aspects described herein, including many of the decision-making steps described herein. For instance, step 304 represents the instance wherein a trained machine learning model is used to identify a predicted amount of a posted transaction (e.g., a final amount, including taxes, tip, and the like) as compared to an authorized amount (e.g., a preliminary amount sent via a point-of-sale machine). For example, the computing device may, provide, as input to a trained machine learning model, at least a portion of the transaction data that indicates an authorized amount of the transaction and then receive, as output from the trained machine learning model, output indicating a predicted difference between the authorized amount of the transaction and a predicted posted amount of the transaction.

The predicted difference between the authorized amount of the transaction and the predicted posted amount of the transaction may correspond to a tip, tax, or similar changes in the final charge for a good or service. To provide an example of this circumstance, a customer may dine at a restaurant and may be presented a check for $100. That check might not include a tip. The machine learning model might be trained (e.g., based on a history of past transactions at the same or similar restaurants) to predict a final amount of the bill, inclusive of tip and other information. For example, the training of the machine learning model may enable to it to know, based on input data such as data corresponding to a particular transaction, information about the relevant consumer, and the like, how much that consumer is likely to pay as a tip. In turn, the machine learning model might predict a $20 tip, or a total posted amount of $120.

The machine learning model may be trained using training data. Such training may be performed by the computing device and/or one or more other devices, such as a third-party vendor. The training data used might vary in scope: for example, while some training data might comprise a history of past transactions that includes both authorized and final posted amounts, other training data might be untagged, might comprise other and/or additional variables, or the like. For example, the computing device may generate the trained machine learning model by training, based on training data comprising a second history of financial transactions, a machine learning model to identify a difference between authorized amounts and corresponding posted amounts. In such a case, as was also described above with respect to FIG. 2, training the machine learning model may comprise modifying, based on the training data, one or more weights of one or more nodes of an artificial neural network.

Machine learning (e.g., different machine learning models) may be used for other steps of the present application. For instance, a different trained machine learning model may be used as part of identifying the predicted quantity of rewards in step 303. To perform this process, a machine learning model might be trained using a history of transactions (e.g., authorization amounts, predicted posted amounts, locations, merchants, etc.) and corresponding rewards provided to user(s). Then, the machine learning model might be provided input data comprising transaction data (e.g., an authorization amount, an indication of a merchant, an indication of a location of the merchant), and the machine learning model might output a predicted rewards amount. As another example, different trained machine learning model may be used to determine the likelihood that a transaction will settle as part of step 305. To perform this process, a machine learning model might be trained using a history of transactions and indications as to whether or not each of those transactions settled. Then, the machine learning model might be provided input data comprising transaction data (e.g., an authorization amount, an indication of a merchant, an indication of a location of the merchant), and the machine learning model might output an indication of a likelihood that the transaction will settle.

Various types of machine learning algorithms might be used herein. For example, various unsupervised learning algorithms (e.g., k-means clustering or related algorithms such as spectral clustering) might be used to cluster transactions in training data into various clusters (e.g., no tip, low tip, high tip, variable tip). In turn, that clustering might be performed on input transactions, which thereby might provide an indication of an expected likelihood of a tip (e.g., if an input transaction appears to be part of a no tip category, then the authorized amount and final amount might be the same, and thus the predicted rewards amount might be identical to the final rewards amount so long as the transaction is not refunded or cancelled). As another example, an unsupervised machine learning algorithm might be used to cluster transactions based on their likelihood of refund (e.g., likely to refund, unlikely to refund), and that clustering might be performed on an input transaction to ascertain the likelihood that the predicted rewards amount will be nullified after a refund/chargeback/etc.

One way that machine learning models may be used is to identify anomalous transactions. Broadly, transactions might be fairly predictable in that transactions at particular merchants (e.g., a grocery store) might generally be within certain amounts (e.g., no more than $200) and within certain times (e.g., during operating hours of the grocery store). In turn, transactions that differ greatly from past transactions might be considered anomalous, which might thereby be at a greater likelihood of refund/chargeback. Such anomalous transactions might be identified by, for example, clustering previous transactions and then determining whether an input transaction appears to be part of a cluster. Indeed, if a transaction appears to be particularly anomalous, the process herein might stop (that is no rewards may be provided) so as to protect all parties from possible fraud.

In step 305, the computing device may determine a likelihood that the transaction will settle. Broadly, it may be undesirable to provide rewards in circumstances where a transaction is very unlikely to be completed. For example, the indication of the transaction in step 302 might simply be a user accessing a “View Cart” screen on a website, such that there is no guarantee that the user actually completes the transaction. Moreover, certain transactions might regularly be refunded by a user and/or otherwise be charged back by the user. In turn, the computing device may be configured to determine whether the transaction indicated in step 302 is likely to be completed. Such a determination may be made by determining a frequency that one or more second (e.g., one or more similar) transactions have settled. For example, the computing device may determine, by comparing the transaction data to a history of financial transactions, a frequency that one or more second transactions similar to the transaction settle.

The likelihood that the transaction will settle may be based on output from one or more machine learning models based on a variety of data points, such as transaction authorization data corresponding to the transaction in question, past transaction data, behavior data, and account data. Transaction authorization data may comprise, for example, an authorized amount, details associated with a merchant (e.g., their merchant category code, their location, whether they are part of a chain), and the like. Past transaction data may comprise historical transactions conducted by a customer (e.g., the customer conducting the transaction), a merchant (e.g., a frequency of transactions at the merchant, a frequency of refunds/chargebacks at the merchant), or the like. Behavior data may comprise habits of the customer (e.g., when and/or where they typically shop, how much they typically spend, their propensity for refunds/chargebacks), and the like. Account data may comprise, for instance, whether the transaction is conducted using a personal or a business charge card, an amount of funds associated with an account used to conduct the transaction, whether the account is associated with suspicious activity, and the like.

In addition to and/or alternative to step 305, the computing device may determine whether instant rewards are likely to be used for the particular transaction. Users might be more likely to acknowledge and react to rewards in some contexts (e.g., instant rebates on groceries) than in others (e.g., the provision of a number of credit card points based on gas purchases). After all, some forms of rewards might be more immediately redeemable than others, and users might be more likely to engage with a rewards program when performing certain types of purchases (e.g., large purchases) than others. Such considerations might be based on transction authorization data (e.g., the amount in question, the merchant), past transaction data (e.g., whether particular transactions at the merchant and/or by the user historically had instant rewards redemptions), behavior data (e.g., the customer's propensity for redeeming rewards instantly), and/or account data (e.g., whether the account carries a balance, whether the user is making interest payments, whether the account is close to a credit limit). Moreover, the determination as to whether instant rewards are likely to be used might be based on the nature of the rewards: for example, customers might be more likely to redeem instant coupons as compared to airline points. In turn, as part of step 305, the computing device may condition further steps (e.g., sending a notification, as discussed below) on a likelihood that the user will redeem the rewards. Such a likelihood might be determined using machine learning techniques (e.g., in a similar manner as described above, by training a machine learning model based on a history of transactions tagged to indicate whether a user redeemed rewards within a certain timeframe) or the like.

In step 306, the computing device may determine whether to send a notification to a user associated with the transaction. The determination as to whether to send the notification may be based on a variety of factors, including transaction data included with the transaction (e.g., whether the transaction data satisfies one or more conditions for the rewards, such as being conducted in a specific location), whether an amount of the transaction (e.g., the predicted posted amount determined in step 304 and/or the authorized amount indicated by the transaction data received in step 302) satisfies the rewards notification threshold, the likelihood that the transaction will settle (and, e.g., will not be charged back or refunded), and the like. If the computing device decides to send a notification, the method 300 proceeds to step 307. Otherwise, the method 300 ends.

The notification may or might not be sent based on user behavior. Different users often have different spending habits, which can influence whether they would likely want to be notified about rewards for a particular transaction. For instance, particularly wealthy and cost-insensitive users might be annoyed with small (e.g., one-dollar) rewards notifications, whereas spendthrift users might like those notifications. As another example, users that regularly use a credit card (e.g., multiple times a day) might be annoyed by rewards notifications for each and every expense, whereas other users that rarely use a credit card might be encouraged to use the credit card more if given a notification. Such user behavior might be based on customer demographics (e.g., user age, user location, user income bracket), past user interactions with notifications (e.g., whether a user appears to interact with and/or ignore notifications relating to rewards), or the like.

In step 307, the computing device may send a notification. The notification may be transmitted to one or more devices (e.g., smartphones) of a user associated with the transaction. For example, the computing device may cause, based on comparing the predicted posted amount of the transaction to the rewards notification threshold, and based on the frequency that the one or more second transactions similar to the transaction settle, output, on a mobile device associated with the user, of a notification indicating the predicted quantity of rewards. Such a notification might be sent via a push notification to a smartphone, to an e-mail to an e-mail address associated with the user, via text messaging to a phone number associated with the user, or the like.

The notification may be sent before the transaction is finalized. A merchant device (e.g., an online shopping server) may send, to the computing device, an indication of a possible transaction that a customer might conduct. For instance, the computing device might receive an indication that a customer has put $300 of items into their cart on an online shopping website, but has not yet finalized their transaction. In turn, the notification might inform the user that they can earn some particular rewards (e.g., a coupon to immediately use for the transaction, an amount of points of the transaction is completed) well before their payment account is actually charged. This may advantageously not only encourage the user to complete the transaction, but it may also allow the user to redeem a reward as part of the transaction itself, rather than after the transaction.

The notification may be part of a security notification. For example, some mobile applications inform users when a payment account is used (e.g., when a credit card is charged). These notifications may be modified to additionally indicate rewards. For example, a standard security notification (e.g., “Your purchase for $50 at STORE was approved.”) may be modified to indicate rewards (e.g., “Your purchase for $50 at STORE was approved, and you earned $2 in rewards on that purchase.”).

Sending a notification may comprise sending, to a point-of-sale device, instructions that cause the point-of-sale device to add information about the rewards to a receipt or similar output. This process may comprise transmitting data to the point-of-sale device such as a number of points (e.g., a number of earned airline points for a particular transaction), a particular string (e.g., a coupon code for a particular transaction), a currency amount (e.g., a number of dollars immediately refunded to the customer's account), or the like. This process may be configured to be performed on a wide variety of point-of-sale devices, such that the rewards might be displayed whether or not the merchant participates in a particular rewards program. For example, various data transmitted as part of a handshake between the point-of-sale system and the issuing bank of a credit card might be modified: the string “BANK NAME CARD” (14 characters total) might be modified to “BANK GOT 3 PTS” (also 14 characters total) or the like to leverage preexisting fields on a receipt to transmit rewards information. To that end, the computing device may maintain various instruction templates for different point-of-sale systems that, to the extent practicable, transmit the rewards information in different ways (e.g., by piggybacking on exiting fields in the manner described above, by adding content to a comments field, or the like).

In step 308, the computing device may receive user input. The user input may be any input made with respect to the notification transmitted in step 307, such as a selection to accept the rewards, an acknowledgement of the rewards, a closing of the notification, or the like. In some cases, the acceptance of the rewards may be conditioned on some specific user input, such as acceptance of the rewards. That said, in other cases, the rewards may be provided regardless of the user input. As such, step 308 might be optional in certain circumstances.

In step 309, the computing device may make the rewards available. As indicated above, this need not be conditioned on the user input in step 308, though in some cases the immediate availability of the rewards may be conditioned on user input. For example, the computing device may, based on user input received in response to the notification, cause a database to store an association between an account of the user and the predicted quantity of rewards. A variety of methods may be used to make the rewards available. For instance, the rewards might be made available by crediting some quantity of points to an account associated with the user. As another example, the rewards may be made available by transmitting, to the user, a coupon code. As yet another example, the rewards may be provided by transmitting, to a third-party server, an indication of the entitlement to the rewards. As the nature of the rewards may vary greatly, the method via which the rewards are provided to a user might be varied as well.

The storing of the association between the account of the user and the predicted quantity of rewards may be performed before the transaction has posted. This might effectuate one significant benefit of the present application: that it can provide access to rewards when a transaction is authorized (or even before such authorization) and well before the lengthy process begins by which the transaction is formally posted (e.g., to an account ledger).

In step 310, the computing device may update rewards. Updating rewards may comprise modifying a quantity and/or nature of one or more rewards based on additional information about the transaction, such as a final posted amount of the transaction and/or whether the transaction was refunded and/or subject to a chargeback. As such, step 310 might be performed long (e.g., hours, days, weeks) after step 309, as it might take some significant amount of time for a transaction to post, be refunded, and/or be subject to a charge back. This may be performed after some period of time has elapsed, such as a time required to post a transaction. For example, the computing device may, based on determining that a predetermined period of time has elapsed, modify the association to indicate a final quantity of rewards.

The final quantity of rewards may be greater, lesser, and/or different than the predicted quantity of rewards. For example, if the actual posted amount is greater than the predicted posted amount determined in step 304, then the rewards may be increased and/or modified accordingly. As another example, if the actual posted amount is lesser than the predicted posted amount determined in step 304, then the rewards may be decreased and/or modified accordingly. An identification of a refund or chargeback may cause the rewards to be withdrawn and/or limited.

There may in some circumstances be a risk that a user is provided and redeems instantly-provided rewards in excess of the rewards to which they were actually entitled. For example, a user might try to cheat the rewards system by making large charges, spending the accompanying rewards, then getting a refund on the large charges. In such a circumstance, the computing device may take a variety of approaches. Where possible, the computing device may modify one or more databases associated with the rewards to indicate a rewards deficit, such as a negative number of points and/or other forms of negative accrual. In this circumstance, the user might be incapable of using rewards in the future until the negative accruals are made positive again through, for example, additional earning of points. Additionally and/or alternatively, such as where the rewards cannot be recovered through additional spending, the user may be charged for the reward.

In step 311, the computing device may further train the trained machine learning model. Broadly, any and/or all of the machine learning models described herein may be continually trained based on subsequent events associated with a transaction. In the context of the machine learning model described with respect to step 304, this may include further training the machine learning model based on whether its predicted posted amount was correct. For example, the computing device may further train the trained machine learning model based on a second difference between a final posted amount of the transaction and the authorized amount of the transaction. In the context of the machine learning model described with respect to step 303, the trained machine learning model may be further trained based on whether the predicted quantity of rewards was, in fact, what was ultimately provided to the user in step 310. In the context of the machine learning model described with respect to step 305, the trained machine learning model may be further trained based on whether the transaction was settled (and, e.g., not charged back, refunded, or the like).

Further training the model may comprise training any one of the previously-referenced machine learning models based on a determination that the transaction was later refunded and/or charged back. For example, based on a determination that a customer returned and item and some or all of the transaction was refunded, one or more trained machine learning models may be further trained with an association between details of the transaction (e.g., transaction authorization data, past transaction data corresponding to the user/merchant, behavior data of the user, account data) and an indication of the refund/chargeback. In this manner, the one or more trained machine learning models may further learn what characteristics of a transaction indicate that the transaction is likely to be charged back and/or refunded.

Further training the model may comprise training any one of the previously-referenced machine learning models based on use of instant rewards. In some cases, it may be advantageous to identify which transactions are associated with instant and/or reasonably quick use of rewards, as this suggests that customers want to engage with a rewards system in those circumstances. For example, in the context of an instant reward as an instant five-dollar-off coupon, use of the coupon for various transactions might be tracked, and the computing device may thereby learn which transactions are often associated with use of the coupon. In turn, the one or more trained machine learning models may be further trained based on the use of (e.g., the timing of use of) instant rewards. In this context, the model(s) might be used to condition provision of instant rewards not merely based on whether the transaction is likely to be charged back/refunded, but also the likelihood that the instant rewards will be utilized.

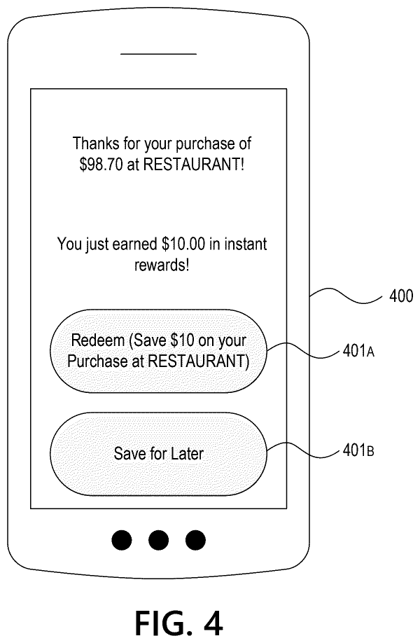

FIG. 4 depicts a notification for instant rewards as displayed on a user interface of a smartphone 400. As illustrated by FIG. 4, in some cases, users might have the ability to instantly redeem rewards to, for example, save money on the same transaction used to generate the rewards (as represented by option 401a) and/or may have the ability to save rewards for a later time (as represented by option 401b). As such, FIG. 4 illustrates one advantage of the present application: by allowing users to immediately acknowledge and use rewards, the users can more readily observe a correlation between their spending activity and the rewards they earn from that spending activity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to provide instant reward gratification, the computing device comprising:
one or more processors; and
memory storing instructions that, when executed by the one or more processors, cause the computing device to:
receive, from a user, a rewards notification threshold;
receive an indication of an authorization of a transaction conducted by the user;
based on the authorization of the transaction, process transaction data corresponding to the transaction to identify a predicted quantity of rewards;
provide, as input to a trained machine learning model, at least a portion of the transaction data that indicates an authorized amount of the transaction;
receive, as output from the trained machine learning model, output indicating a predicted difference between the authorized amount of the transaction and a predicted posted amount of the transaction;
determine, by comparing the transaction data to a history of financial transactions, a frequency that one or more second transactions similar to the transaction settle;
cause, based on comparing the predicted posted amount of the transaction to the rewards notification threshold, and based on the frequency that the one or more second transactions similar to the transaction settle, output, on a mobile device associated with the user, of a notification indicating the predicted quantity of rewards;
based on user input received in response to the notification, cause a database to store an association between an account of the user and the predicted quantity of rewards, wherein the predicted quantity of rewards are immediately usable by the user; and
based on determining that a predetermined period of time has elapsed, modify the association to indicate a final quantity of rewards.

2. The computing device of claim 1, wherein the instructions, when executed by the one or more processors, further cause the computing device to:
generate the trained machine learning model by training, based on training data comprising a second history of financial transactions, a machine learning model to identify a difference between authorized amounts and corresponding posted amounts, wherein training the machine learning model comprises modifying, based on the training data, one or more weights of one or more nodes of an artificial neural network.

3. The computing device of claim 1, wherein the final quantity of rewards is greater than the predicted quantity of rewards.

4. The computing device of claim 1, wherein the instructions, when executed by the one or more processors, further cause the computing device to cause the database to store the association before the transaction is posted, and wherein the determining that a predetermined period of time has elapsed comprises determining that the transaction has posted.

5. The computing device of claim 1, wherein the predicted difference between the authorized amount of the transaction and the predicted posted amount of the transaction comprises an indication of a quantity of a tip.

6. The computing device of claim 1, wherein the instructions, when executed by the one or more processors, further cause the computing device to process the transaction data corresponding to the transaction to identify the predicted quantity of rewards by causing the computing device to:
determine, based on the transaction data, whether the transaction was conducted at a particular merchant.

7. The computing device of claim 1, wherein the instructions, when executed by the one or more processors, further cause the computing device to:
further train the trained machine learning model based on a second difference between a final posted amount of the transaction and the authorized amount of the transaction.

8. A method for providing instant reward gratification, the method comprising:
receiving, from a user, a rewards notification threshold;
receiving an indication of an authorization of a transaction conducted by the user;
based on the authorization of the transaction, processing transaction data corresponding to the transaction to identify a predicted quantity of rewards;
providing, as input to a trained machine learning model, at least a portion of the transaction data that indicates an authorized amount of the transaction;
receiving, as output from the trained machine learning model, output indicating a predicted difference between the authorized amount of the transaction and a predicted posted amount of the transaction;
determining, by comparing the transaction data to a history of financial transactions, a frequency that one or more second transactions similar to the transaction settle;
causing, based on comparing the predicted posted amount of the transaction to the rewards notification threshold, and based on the frequency that the one or more second transactions similar to the transaction settle, output, on a mobile device associated with the user, of a notification indicating the predicted quantity of rewards;
based on user input received in response to the notification, causing a database to store an association between an account of the user and the predicted quantity of rewards, wherein the predicted quantity of rewards are immediately usable by the user; and
based on determining that a predetermined period of time has elapsed, modifying the association to indicate a final quantity of rewards.

9. The method of claim 8, further comprising:
generating the trained machine learning model by training, based on training data comprising a second history of financial transactions, a machine learning model to identify a difference between authorized amounts and corresponding posted amounts, wherein training the machine learning model comprises modifying, based on the training data, one or more weights of one or more nodes of an artificial neural network.

10. The method of claim 8, wherein the final quantity of rewards is greater than the predicted quantity of rewards.

11. The method of claim 8, wherein the causing the database to store the association comprises causing the database to store the association before the transaction is posted, and wherein the determining that a predetermined period of time has elapsed comprises determining that the transaction has posted.

12. The method of claim 8, wherein the predicted difference between the authorized amount of the transaction and the predicted posted amount of the transaction comprises an indication of a quantity of a tip.

13. The method of claim 8, wherein the processing the transaction data corresponding to the transaction to identify the predicted quantity of rewards comprises:
determining, based on the transaction data, whether the transaction was conducted at a particular merchant.

14. The method of claim 8, further comprising:
further training the trained machine learning model based on a second difference between a final posted amount of the transaction and the authorized amount of the transaction.

15. One or more non-transitory computer-readable media storing instructions configured to provide instant reward gratification, wherein the instructions, when executed by one or more processors of a computing device, cause the computing device to:
receive, from a user, a rewards notification threshold;
receive an indication of an authorization of a transaction conducted by the user;
based on the authorization of the transaction, process transaction data corresponding to the transaction to identify a predicted quantity of rewards;
provide, as input to a trained machine learning model, at least a portion of the transaction data that indicates an authorized amount of the transaction;
receive, as output from the trained machine learning model, output indicating a predicted difference between the authorized amount of the transaction and a predicted posted amount of the transaction;
determine, by comparing the transaction data to a history of financial transactions, a frequency that one or more second transactions similar to the transaction settle;
cause, based on comparing the predicted posted amount of the transaction to the rewards notification threshold, and based on the frequency that the one or more second transactions similar to the transaction settle, output, on a mobile device associated with the user, of a notification indicating the predicted quantity of rewards;
based on user input received in response to the notification, cause a database to store an association between an account of the user and the predicted quantity of rewards, wherein the predicted quantity of rewards are immediately usable by the user; and
based on determining that a predetermined period of time has elapsed, modify the association to indicate a final quantity of rewards.

16. The one or more non-transitory computer-readable media of claim 15, wherein the instructions, when executed by the one or more processors, further cause the computing device to:
generate the trained machine learning model by training, based on training data comprising a second history of financial transactions, a machine learning model to identify a difference between authorized amounts and corresponding posted amounts, wherein training the machine learning model comprises modifying, based on the training data, one or more weights of one or more nodes of an artificial neural network.

17. The one or more non-transitory computer-readable media of claim 15, wherein the final quantity of rewards is greater than the predicted quantity of rewards.

18. The one or more non-transitory computer-readable media of claim 15, wherein the instructions, when executed by the one or more processors, further cause the computing device to cause the database to store the association before the transaction is posted, and wherein the determining that a predetermined period of time has elapsed comprises determining that the transaction has posted.

19. The one or more non-transitory computer-readable media of claim 15, wherein the predicted difference between the authorized amount of the transaction and the predicted posted amount of the transaction comprises an indication of a quantity of a tip.

20. The one or more non-transitory computer-readable media of claim 15, wherein the instructions, when executed by the one or more processors, further cause the computing device to process the transaction data corresponding to the transaction to identify the predicted quantity of rewards by causing the computing device to:
determine, based on the transaction data, whether the transaction was conducted at a particular merchant.
